(19) United States
(12) Patent Application Publication
(10) Pub. No.: US 2018/0164139 A1
(43) Pub. Date: Jun. 14, 2018

(54) MAGNETO-INDUCTIVE FLOW MEASURING DEVICE FOR MEASURING FLOW VELOCITY OR VOLUME FLOW RATE OF MEDIA IN A PIPELINE AND METHOD FOR MANUFACTURING SUCH A FLOW MEASURING DEVICE

(71) Applicant: Endress + Hauser Flowtec AG, Reinach (CH)

(72) Inventors: Frank Voigt, Weil am Rhein (DE); Ole Koudal, Oberrohrdorf (CH); Jorg Kowalski, Weil am Rhein (DE)

(21) Appl. No.: 15/738,202

(22) PCT Filed: Jun. 22, 2016
(86) PCT No.: PCT/EP2016/064377

§ 371 Date: Dec. 20, 2017

(30) Foreign Application Priority Data
Jul. 23, 2015 (DE) 10 2015 112 018.6

(51) Int. Cl. G01F 15/00; G01F 1/58; B22F 5/10; B22F 7/08

(52) U.S. Cl. CPC G01F 15/006; B22F 7/08; B22F 5/106; G01F 1/584

(57) ABSTRACT

A hybrid electrode for use in magneto-inductive flow measuring devices, characterized in that the hybrid electrode is manufactured of a body and an electrode head, wherein the electrode head is produced with a method based on selective material deposition and is connected with the body by material bonding at least in an edge region.

The invention relates to a magneto-inductive flow measuring device comprising a hybrid electrode as well as to a method for manufacturing such a hybrid electrode.

Magneto-inductive measuring devices use electrodes, in order to sense the electrical voltage produced in a medium when the medium is flowing through an applied magnetic field. Since the applications of such measuring devices often involve difficult conditions, such as, for example, the presence of corrosive and/or hot media, high demands are placed on the materials of such electrodes. Electrodes according to the state of the art are frequently manufactured from a workpiece, such as disclosed, for example, in the documents, WO 2010/015534 A1 and WO 2009/071615. Preferred materials for manufacture of electrodes are noble metals, such as platinum, gold or tantalum, due to their good conductivity and tolerance of difficult chemical conditions. Due to the high material costs of these metals, electrodes produced from these metals are very expensive.

An object of the present invention is to manufacture a hybrid electrode composed of two parts, a body of an advantageous material and an electrode head of a material preferred for the electrode head, wherein the electrode head is connected with the body at least partially by material bonding. In this way, the application of more expensive materials can be limited to the manufacture of the electrode head. The object is achieved according to the invention by an apparatus in the form of a magneto-inductive flow measuring device as defined in independent claim 1 and by a method for manufacturing a hybrid electrode as defined in independent claim 13.

The apparatus of the invention is provided in the form of a magneto-inductive flow measuring device, comprising: a measuring tube with a magnet system and at least one pair of hybrid electrodes; wherein the magnet system is arranged on the measuring tube, wherein the inner surface of the measuring tube is composed of an insulating, media-contacting material, and wherein the hybrid electrodes are arranged in the insulating surface; wherein a hybrid electrode includes at least one body of a first material and has at least one electrode head, which contacts the medium and is connected with the body; wherein the electrode head has a surface facing away from the body and composed of a second material of metal; wherein the hybrid electrode is characterized in that the electrode head is connected with the body by material bonding at least in an edge region.

In an embodiment of the flow measuring device, the electrode head is at least partially produced by selective material deposition, wherein a metal powder is transformed into a metal layer by a material bonding, melt-on method. The material bonding, melt-on method can be based, for example, on laser sintering or laser melting.

In an embodiment of the flow measuring device, the material comprising the metal powder is platinum or preferably tantalum or especially titanium. In an embodiment of the flow measuring device, the hybrid electrode has at least one hollow space, which is arranged especially between body and electrode head or in the electrode head. In this way, the consumption of costly materials for manufacturing the hybrid electrodes can be significantly lessened.

In an embodiment of the flow measuring device, the hybrid electrode has at least one opening to the at least one hollow space, wherein the opening is isolated from the medium by the insulating material. In the case of hybrid electrodes manufactured by selective material deposition, the hollow space is produced by leaving the metal powder powdered in the region of the hollow space and removing the powder after termination of the material deposition method. By having at least one opening to the hollow space, the metal powder present in the hollow space can be removed, for example, by rinsing, and utilized for other manufacturing processes.

In an embodiment of the flow measuring device, the body has at least sectionally a cylindrical shaft with an external thread, wherein the external thread extends over at least 10% and especially at least 20% and at most 100% and especially at most 70% of the shaft length. The external thread is adapted to anchor the hybrid electrode in the measuring tube by force interlocking, e.g. frictional interlocking.

In an embodiment of the flow measuring device, the surface area ratio of electrode head to body is at least 3:1 and especially at least 4:1 and at most 6:1 and especially at most 5:1.

In an embodiment of the flow measuring device, the electrode head includes on its end facing the tube wall of the flow measuring device an axial abutment surface, characterized in that the electrode head has on its abutment surface a sealing lip, which serves to seal the electrode head against the tube wall. In this way, it is assured that corrosive media cannot come into contact with the body and the functional ability of the hybrid electrodes is retained.

In an embodiment of the flow measuring device, the shape of the axial abutment surface of the electrode head conforms to the cross section of the inside of the tube wall. Especially in the case of flow measuring devices with small tube wall inner diameters, the shape difference between a planar axial abutment surface and the inner surface of the measuring tube is important, so that the electrode head must be pressed against the insulating, media-contacting material, in order to assure a sufficient seal between electrode head and inner surface. By matching the shape of the axial abutment surface to the shape of the inner surface of the measuring tube, the necessary pressing force and, thus, the load on the insulating material can be significantly lessened.

In an embodiment of the flow measuring device, the surface of the electrode head directed toward the medium has a flow optimized shape. Especially in the case of small measuring tube inner diameters, measuring electrodes can significantly influence a flow of a medium flowing by them. The surface of a hybrid electrode of the invention in contact with the medium can, for example, be characterized in that it offers a minimum flow resistance. In the case of laminar flow, occurring vortices mean an increased flow resistance. A hybrid electrode of the invention can have a surface, which prevents the occurrence of vortices in flows in the region of the surface and, thus, contributes to a low flow resistance. The hybrid electrode of the invention can, for example, also be adapted to keep turbulence density constant in turbulent flows.

In an embodiment of the flow measuring device, the metal surface in contact with the medium has a coating thickness of at least 0.5 mm and especially at least 0.8 mm and at most 5 mm and especially at most 2 mm.

In an embodiment of the flow measuring device, the surface in contact with the medium has, to at least 30% and preferably to at least 50% and especially is to at least 70%, a constant coating thickness.

A method of the invention for manufacturing hybrid electrodes is characterized in that the method for manufacturing the hybrid electrode is based on selective material deposition and comprises method steps as follows:
applying metal powder on the body or electrode head,
melting-on the metal powder for achieving material bonding,
repeating the preceding steps until a desired shape of metal layer is achieved;
wherein the structural density of the metal powder after bonding achieves at least 95% and especially at least 99% of the structural density of a completely metal body of the material of the metal powder.

In an embodiment of the method, the method for selective material deposition is based on selective laser melting and comprises method steps as follows: applying metal powder on the body or electrode head, selectively melting-on the metal powder by laser melting for achieving material bonding, repeating the preceding steps until a desired shape is achieved.

Thus, the present invention provides a magneto-inductive flow measuring device comprising at least one pair of hybrid electrodes and a method for manufacturing a hybrid electrode.

The invention will now be explained in greater detail based on examples of embodiments illustrated in the appended drawing, the figures of which show as follows:

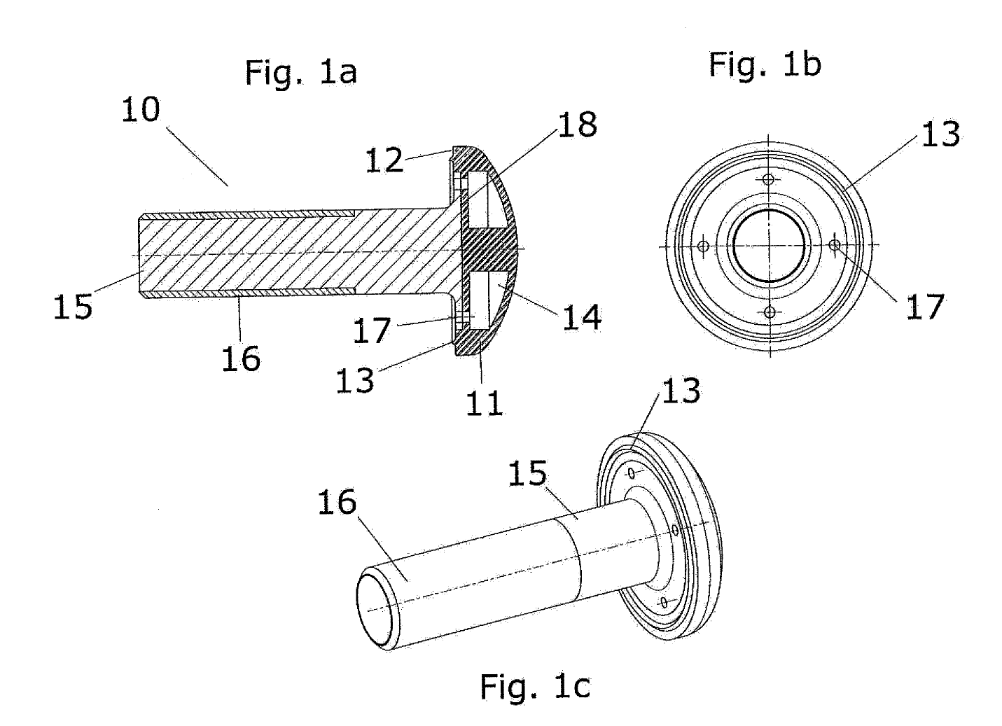

FIG. 1a a cross section through a hybrid electrode of the invention;

FIG. 1b a plan view onto an axial abutment surface of an electrode head and an end of the body facing away from the electrode head;

FIG. 1c a perspective, external view of the hybrid electrode; and

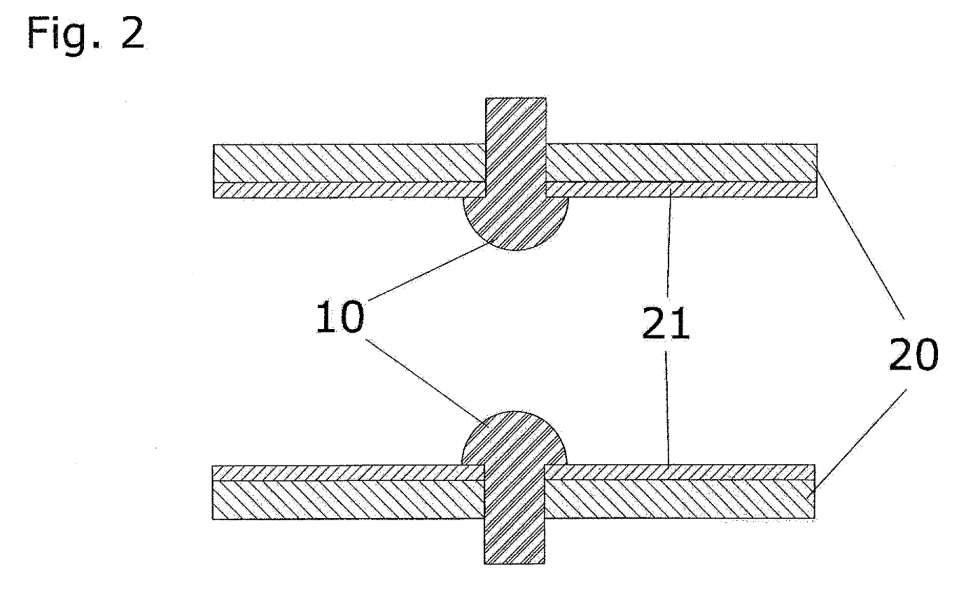

FIG. 2 a longitudinal section through a measuring tube of a magneto-inductive flow measuring device of the invention.

The cross section of the hybrid electrode 10 shown in FIG. 1 a illustrates an electrode head 11 and a body 15 with a cylindrical shaft, wherein the electrode head 11 is connected with the body 15 at the contact area 18 by material bonding; wherein the electrode head 11 has a hollow space 14, and a sealing lip 13 on the axial abutment surface 12; wherein the body has an external thread 16 and a number of openings 17. Metal powder left powdered in the region of the hollow space 14 during selective material deposition is removed through the openings 17 to the hollow space 14 after termination of the material deposition method, for example, by rinsing, and can be used for other purposes.

The plan view in FIG. 1 b onto the axial abutment surface 12 and the end of the body facing away from the electrode head 11 shows a sealing lip 13 extending on the axial abutment surface 12 and four openings 17.

The perspective external view of the hybrid electrode shown in FIG. 1c brings together the features of the hybrid electrode shown in FIGS. 1a and 1b.

FIG. 2 shows pairwise insertion of hybrid electrodes 10 into a measuring tube 20 having an insulating and media-contacting material 21, which lines the inner surface of the measuring tube.

### LIST OF REFERENCE CHARACTERS

10 hybrid electrode
11 electrode head
12 axial abutment surface
13 sealing lip
14 hollow space
15 body
16 external thread
17 opening
18 contact area
20 measuring tube
21 insulating material

1-14. (canceled)

15. A magneto-inductive flow measuring device for measuring flow velocity or volume flow rate of media in a pipeline, comprising:
a measuring tube with a magnet system arranged on said measuring tube;
the inner surface of said measuring tube is composed of an insulating, media-contacting material; and
at least one pair of hybrid electrodes, wherein:
said at least one part of hybrid electrodes are arranged in said insulating material;
a hybrid electrode includes at least one body of a first material and has at least one electrode head, which contacts the medium and is connected with said at least one body;
the electrode head has a surface facing away from said at least one body and composed of a second material of metal; and
said hybrid electrode is characterized in that said at least one electrode head is connected with said at least one body by material bonding at least in an edge region.

16. The magneto-inductive flow measuring device as claimed in claim 15, wherein:
said at least one electrode head is at least partially produced by selective material deposition; and
a metal powder is transformed into a metal layer by a material bonding, melt-on method.

17. The magneto-inductive flow measuring device as claimed in claim 16, wherein:
the material comprising the metal powder is platinum or preferably tantalum or especially titanium.

18. The magneto-inductive flow measuring device as claimed in claim 15, wherein:
said hybrid electrode has at least one hollowspace, which is arranged between said at least one body and said at least one electrode head, or in said at least one electrode head.

19. The magneto-inductive flow measuring device as claimed in claim 18, wherein:
said hybrid electrode has at least one opening to said at least one hollow space; and
said at least one opening is isolated from the medium by the insulating material.

20. The magneto-inductive flow measuring device as claimed in claim 17, wherein:
said at least one body has at least sectionally a cylindrical shaft with an external thread;
said external thread extends over at least 10% and especially at least 20% and at most 100% and especially at most 70% of the shaft length.

21. The magneto-inductive flow measuring device as claimed in claim 15, wherein:
the surface area ratio of said at least one electrode head to said at least one body is at least 3:1 and especially at least 4:1 and at most 6:1 and especially at most 5:1.

22. The magneto-inductive flow measuring device according to claim 15, wherein:
said electrode head includes on its end facing the tube wall of the flow measuring device an axial abutment surface; and
said at least one electrode head has on its abutment surface a sealing lip, which serves to seal said at least one electrode head against the insulating material.

23. The magneto-inductive flow measuring device as claimed in claim 15, wherein:
the shape of the axial abutment surface of said at least one electrode head conforms to the cross section of the inside of the tube wall.

24. The magneto-inductive flow measuring device as claimed in claim 15, wherein:
the surface of said at least one electrode head directed toward the medium has a flow optimized shape.

25. The magneto-inductive flow measuring device as claimed in claim 15, wherein:
the metal surface in contact with the medium has a coating thickness of at least 0.5 mm and especially at least 0.8 mm and at most 5 mm and especially at most 2 mm.

26. The magneto-inductive flow measuring device as claimed in claim 24, wherein:
the insulating material in contact with the medium has, to at least 30% and preferably to at least 50% and especially to at least 70%, a constant coating thickness.

27. A method for manufacturing hybrid electrodes as claimed in claim 15 is based on selective material deposition and comprises the method steps as follows:
applying metal powder on the body or electrode head;
melting-on the metal powder for achieving material bonding; and
repeating the preceding steps until a desired shape of metal layer is achieved, wherein:
the structural density of the metal powder after bonding achieves at least 95% and especially at least 99% of the structural density of a completely metal body of the material of the metal powder.

28. The method as claimed in claim 27, wherein:
the method for selective material deposition is based on selective laser melting and comprises the method steps as follows:
applying metal powder on the body or electrode head;
selectively melting-on the metal powder by laser melting for achieving material bonding; and
repeating the preceding steps until a desired shape is achieved.
